(19) United States
(12) Patent Application Publication
(10) Pub. No.: US 2014/0015810 A1
(43) Pub. Date: Jan. 16, 2014

(54) COMPACT CONDUCTIVE STYLUS

(71) Applicant: Jack Chau, Troy, MI (US)

(72) Inventor: Jack Chau, Troy, MI (US)

(21) Appl. No.: 13/653,426

(22) Filed: Oct. 17, 2012

(30) Foreign Application Priority Data
Jul. 16, 2012 (CN) 201210245433.4
Jul. 16, 2012 (CN) 201220343700.7

(51) Int. Cl. G06F 3/033

(52) U.S. Cl. 345/179

(57) ABSTRACT

Disclosed is a compact conductive stylus comprising: a core configured to assume and maintain either of two bi-stable states, the core formed from an elongated flexible material; an electrically-conductive nib attached to an end of the core; and a soft capsule layer enclosing the core.

### CROSS-REFERENCE TO RELATED APPLICATION

The present Application is related to Chinese Utility Patent Application entitled “A Unusual Shaped Conductive Stylus Pen,” filed on 16 Jul. 2012 and assigned filing number 201220343700.7, and Chinese Utility Patent Application entitled “A Unusual Shaped Conductive Stylus Pen,” filed on 16 Jul. 2012 and assigned filing number 201210245433.4, both incorporated herein by reference in their entireties.

### FIELD OF THE INVENTION

The present invention relates to conductive styluses for use on capacitive touch screen devices and, in particular, to a compact conductive stylus that provides increased accuracy of utilization and which can be conveniently carried and stored when not in use.

### BACKGROUND OF THE INVENTION

In the present state of the art, an induction effect produced by a human body is used to produce a weak bioelectrical signal on the screen surface of a capacitive touch-screen device. However, as most handheld touch-screen devices present a relatively small screen size to the user, the displayed graphics and text are correspondingly small, dense, and crowded because of the physical size of the touch screen. When such a small touch screen is manually operated by a user, the disproportionately larger size of a finger on a small screen often causes a mistype or an incorrect command because of the difficulty of accurate finger placement, and may therefore create an undesired selection or output in the handheld device.

To avoid or mitigate such errors, the touch screen user may alternatively employ a stylus as a contact device on the capacitive touch screen device as a means of increasing accuracy and control. However, as most conventional touch-screen styluses are manufactured as cylindrical “pen” configurations, the conventional stylus user often needs to store the pen-shaped stylus in a pocket or in a bag when not in use. Accordingly, when the user misplaces, or forgets to carry the stylus, the user may need to resort back to the traditional way of operating the touch screen device, by using fingers.

What is needed is a stylus which overcomes the above-noted shortcomings of the present state of the art by providing a compact conductive stylus that operates on the surface of a conductive touch screen, while providing accuracy of selection on the screen and which offers a means of conveniently storing the stylus when not in use.

### BRIEF SUMMARY OF THE INVENTION

In one aspect of the present invention, a compact conductive stylus comprises: a core configured to assume and maintain either of two bi-stable states, the core formed from an elongated flexible material; a first electrically-conductive nib attached to a first end of the core; and a soft capsule layer enclosing the core.

In another aspect of the present invention, a compact conductive stylus comprises: a core configured to assume and maintain either of two bi-stable states, the core having an arcuate cross-sectional shape and formed from an elongated flexible material; an electrically-conductive nib attached to the core, the electrically-conductive nib formed from a conducting non-metallic material; and a soft capsule layer enclosing the core.

In still another aspect of the present invention, a method for fabricating a compact conductive stylus comprises: obtaining a core configured to selectively assume and maintain either of two bi-stable states; attaching an electrically-conductive nib to the core; and enclosing the core in a soft capsule layer overlying the core.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

FIG. 1 is an isometric view of a compact conductive stylus in a linear configuration, the stylus comprising first electrically-conductive nib at a first end of a stylus core, and an optional second electrically-conductive nib at a second end of the stylus core, in accordance with the present invention;

FIG. 2 is a top view of the stylus of FIG. 1;

FIG. 3 is a cross sectional view of the stylus of FIG. 1 showing a soft capsule coating disposed on and enclosing a bi-stable, flexible core;

FIG. 4 is an isometric view of the stylus of FIG. 1 in a coiled configuration;

FIG. 5 is a top view of an embodiment of the stylus of FIG. 1 with electrically-conductive nibs disposed on conductive pins;

FIG. 6 is an illustration showing a detail view of the core of FIG. 5, showing attachment of a conductive pin to the core and attachment of the electrically-conductive nib to the conductive pin;

FIG. 7 is a top view of an embodiment of the stylus of FIG. 1 with electrically-conductive nibs disposed over respective ends of the core;

FIG. 8 is an illustration showing a detail view of the core of FIG. 7, showing attachment of an electrically-conductive nib attachment skirt to an end of the core;

FIG. 9 is an embodiment of the stylus of FIG. 1 with electrically-conductive nibs secured with tabs to respective ends of the core;

FIG. 10 is an illustration showing a detail view of the core of FIG. 9, showing attachment of the tab of the electrically-conductive nib to an end of the core;

FIG. 11 is an embodiment of the stylus of FIG. 1 with electrically-conductive nibs mechanically attached to respective ends of the core;

FIG. 12 is an illustration showing a detail view of the core of FIG. 11, showing emplacement of a threaded/ribbed end of the electrically-conductive nib in a serrated opening in an end of the core; and

FIG. 13 is a flow diagram illustrating fabrication of the stylus embodiments of FIGS. 1, 7, 9, and 11.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In order to overcome the deficiencies of the prior art, the disclosed compact conductive stylus is based on the technical solution as follows: the stylus body shape can be converted between a usage mode and a storage mode by straightening or bending. The stylus comprises a core enclosed in a soft capsule coating with an electrically-conductive nib at one or both ends. The soft capsule coating may be integral with the core. The core may be a flexible component having a generally arcuate shape, as seen in a transverse section view, allowing the stylus to be formed into a hoop or coil when stored, as explained in greater detail below. When the user straightens out the stored stylus body to form a linear stylus, the electrically-conductive nib can be used to operate a touch screen device.

Greater display screen accuracy is thus achieved due to the relatively small contact area of the electrically-conductive nib and increased visibility of the touch screen surface when only the nib of the stylus is placed on the display screen. Accordingly, a selected region or icon on the display screen can be targeted without inadvertently touching a non-targeted graphic. It can be appreciated that benefits realized by using the compact conductive stylus are: (i) avoiding mistakes of touch-screen-control, and (ii) compacting the size of the stylus body to provide ease of carrying and storage when not in use.

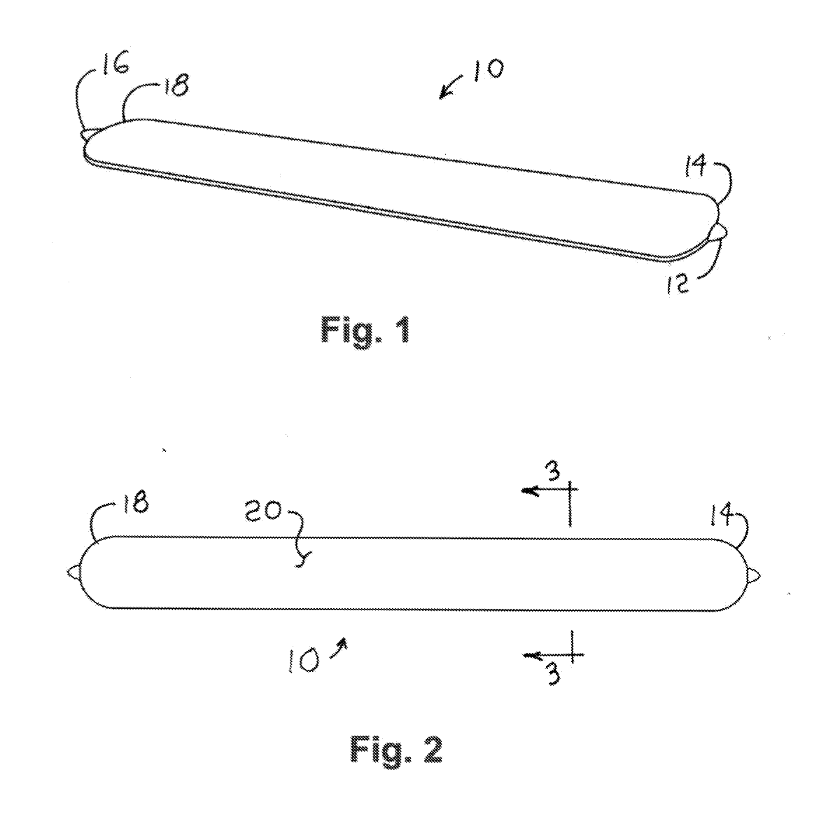

There is shown in FIG. 1 an isometric view of a compact conductive stylus 10, in accordance with the present invention. In the exemplary embodiment shown, the stylus 10 comprises a first electrically-conductive substantially spherically or conically-shaped nib 12 at a first end 14 of the stylus 10, and an optional second electrically-conductive nib 16 at a second end 18 of the stylus 10. That is, the stylus 10 may be provided with only the first nib 12, or with both nibs 12, 16.

It should be understood that, although both the first nib 12 and the second nib 16 are substantially spherically or conically-shaped, the geometrical configuration of the second nib 16 may be different from the first nib 12 to allow the user the flexibility of switching between nibs of different widths, lengths, rigidity, and/or geometries, in accordance with a desired method of operating a capacitive touch screen (not shown). In an exemplary embodiment, the nibs 12, 16 may be formed from an electrically-conductive non-metallic material, such as can be produced by impregnating silicone rubber with one or more of carbon particles, silver particles, and copper particles.

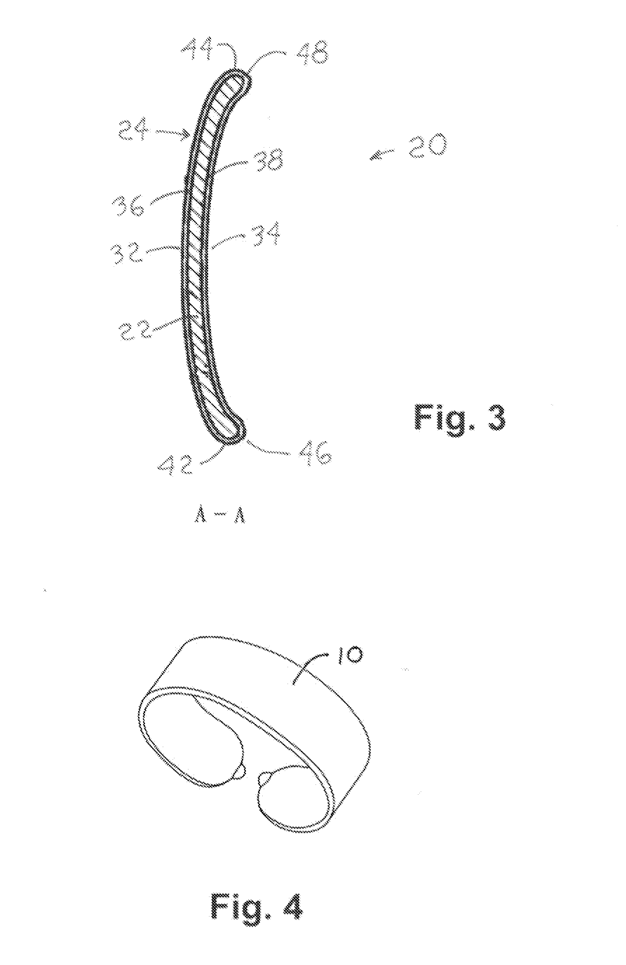

As shown in FIG. 2, the stylus 10 includes an elongated stylus body 20 configured with rounded ends. As best seen in the cross-sectional view of FIG. 3, the stylus body 20 comprises an elongated flexible core 22 enclosed in a soft capsule coating 24, where the soft capsule coating may be formed in two parts for ease of emplacement on the flexible core 22. The soft capsule coating 24 substantially covers most or all of the stylus body 20, from a rounded first end 14 to a rounded second end 18, but leaves exposed the tips of the first nib 12 and the optional second nib 16 (when provided). The core 22 has an arcuate cross-sectional shape, and may be formed from a material capable of being flexed, such as a metal or a non-brittle plastic. In an exemplary embodiment, the core 22 may comprise steel or aluminum, for example, and the soft capsule coating 24 may be fabricated from a pliant plastic material of sufficient thickness to provide tactile comfort to the user.

It can be appreciated by one skilled in the relevant art that the arcuate shape of the core 22 serves to retain the stylus 10 in either the linear state shown in FIG. 1, or in a coiled state shown in FIG. 4. The bending force required to change the state of the stylus between linear and coiled may be specified by a product designer and is a function of: (i) the radius of curvature of the arcuate cross-sectional shape, (ii) the length of the core 22, (iii) the modulus of elasticity of the material used to form the core 22, and (iv) the thickness of the core 22.

In an exemplary embodiment, the thickness of the material used to form the core 22 may be between about 0.20 mm and 0.60 mm, and the radius of curvature of the cross-sectional shape of the core 22 may be about 20 mm to about 80 mm. In an exemplary embodiment, the overall length of the stylus 10 may be about 150 mm to about 250 mm, the width of the stylus 10 may be about 15 mm to about 30 mm, and the arcurate height of the core 22 with the layers of the soft capsule coating 24 disposed on the core 22 may be about 4 mm to about 12 mm. The nibs 12, 16 may be about 3 mm to about 9 mm in diameter with a protrusion of about 2 mm to about 8 mm from the rounded first end 14 or the rounded second end 18.

As can be appreciated by one skilled in the art, the arcuate cross sectional shape provides for a physical component structure that allows the user to selectively place and retain the stylus 10 in a straightened, linear configuration, as shown in FIG. 1, or to coil and retain the stylus 10 in a hoop or wrist-band configuration, as shown in FIG. 4. That is, the stylus 10, and in particular the core 22, exhibit the mechanical property of being able to assume either of two bi-stable states—a substantially linear or straightened state, and a more compact coiled or wrist-band state.

When the user desires to operate the touch screen, the user can straighten the stylus body 20 to function as the stylus in place of the user's fingers. The geometry of the core 22 prevents the linear stylus 10 from resorting to the coiled state, unless the user wishes to intentionally change the configuration of the stylus 10. The electrically conductive material on the nibs 12, 16 can thus be used to accurately control the touch screen.

When the stylus 10 is not in use, the user can bend the flexible stylus body 20 into the hoop, coiled roll, or wrist-band form to allow for storage as the user may desire. This shape change and compaction enables a feature of the stylus 10 that makes it convenient for the user to adapt for carrying, such as wearing on a wrist, or clamping onto a carrying case, or storing in a compartment or pocket.

In an exemplary embodiment, the soft capsule coating 24 may comprise a first capsule layer segment 32 positioned on a first side 36 of the core 22, and a second capsule layer segment 34 positioned on a second side 38 of the core 22, as shown in FIG. 3. In an exemplary embodiment, the first capsule layer segment 32 and the second capsule layer segment 34 may comprise pre-cut sheets of a soft, pliable plastic approximately 0.4 mm to about 1.5 mm thick. To complete fabrication of the stylus 10, the first layer segment 32 may be attached directly to the first side 36 of the core 22 by bonding, for example, and the second capsule layer segment 34 may likewise be attached to the second side 38 of the core 22 by bonding or by a thermal attachment method, to form a unitary soft capsule 24.

In an alternate method of fabrication, the soft capsule coating 24 may be formed by: (i) providing the first capsule layer segment 32; (ii) placing the core 22, the nib 12, and the nib 16 (when used) onto the first capsule layer segment 32; (iii) placing the second capsule layer segment 34 onto the core 22, the nib 12, and the nib 16 (when used); and (iv) physically attaching the edges 42, 44 of the first capsule layer segment 32 to the respective edges 46, 48 of the second capsule layer segment 34, for example, by heat sealing or by bonding.

In an exemplary embodiment, shown in FIG. 5, a stylus 50 may comprise a core 52 with a first conductive pin 54 attached to a first end of the core 52 and an optional conductive pin 56 attached to a second end of the core 52. The soft capsule coating 24 may cover or enclose substantially all of the core 52, and may further cover a portion of the conductive pins 56, 58. A first nib 62 may be placed over the first conductive pin 54, and an optional second nib 64 may be placed over the second conductive pin 56.

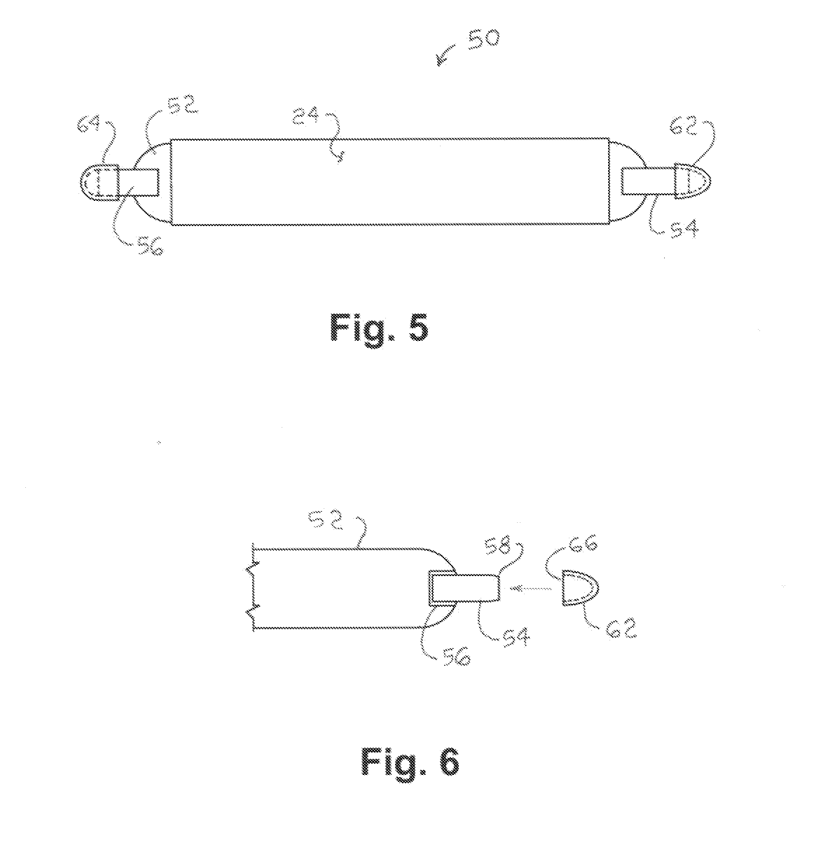

As shown in the detail view of FIG. 6, the first nib 62 includes an open cavity 66 shaped and sized so as to frictionally engage the first conductive pin 54. A pin end 58 of the first conductive pin 58 may be tapered, as shown, to allow for emplacement of the first nib 62 over the end of the first conductive pin 58. In an exemplary embodiment, the pin end 58 may be flared (not shown) so as to more positively retain the first nib 62 after being placed over the first conductive pin 54. As can be appreciated by one skilled in the art, an electrically-conductive path may thereby provided from a users hand, through the core 52, through the first conductive pin 54, through the first nib 62, and onto a touch-sensitive display screen (not shown).

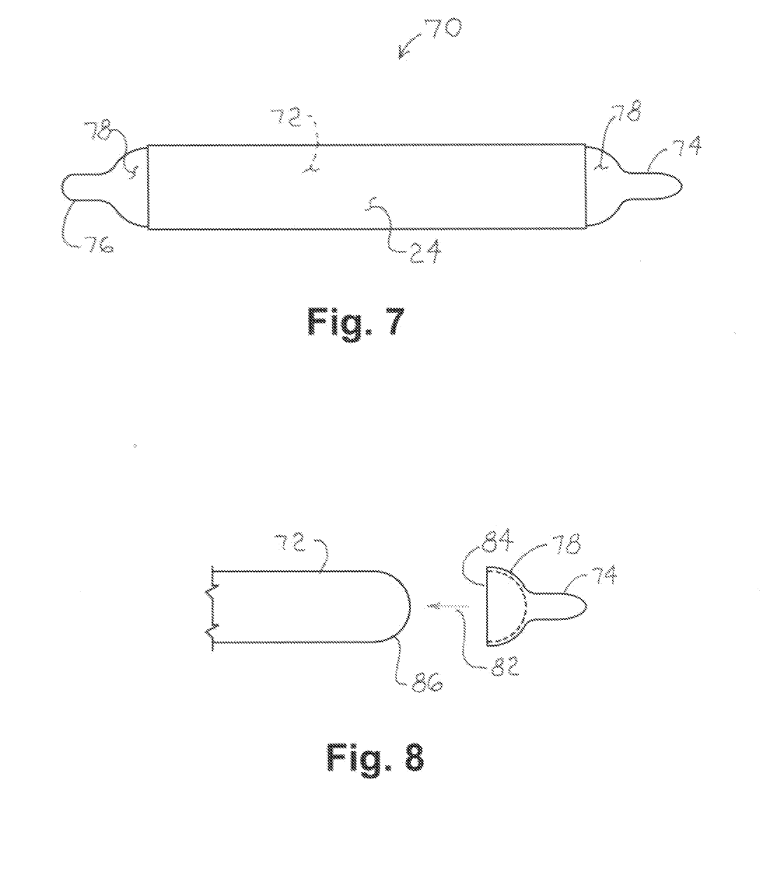

In an exemplary embodiment, a stylus 70 may comprise a core 72 configured for attachment to a first nib 74 and an optional second nib 76, as shown in FIG. 7. The nibs 74, 76 may each comprise an integral skirt-like attachment end 78 by which attachment to the core 72 may be accomplished. The skirt-like attachment end 78 of the first nib 74 may include an open cavity 84 that may be slipped over a first end 86 of the core 72, as shown in FIG. 8, where the skirt-like attachment end 78 is shaped and sized to retain the nibs 72, 76 in place on the core 72 during fabrication of the stylus 70. The soft capsule coating 24 may be formed over the core 72, the skirt-like attachment end 78 of the first nib 72, and the skirt-like attachment end 78 of the second nib 76 (when used). This action serves to more positively hold the nibs 72, 76 in place, and thus complete a process by which the stylus 70 may be fabricated to the configuration shown in FIG. 7.

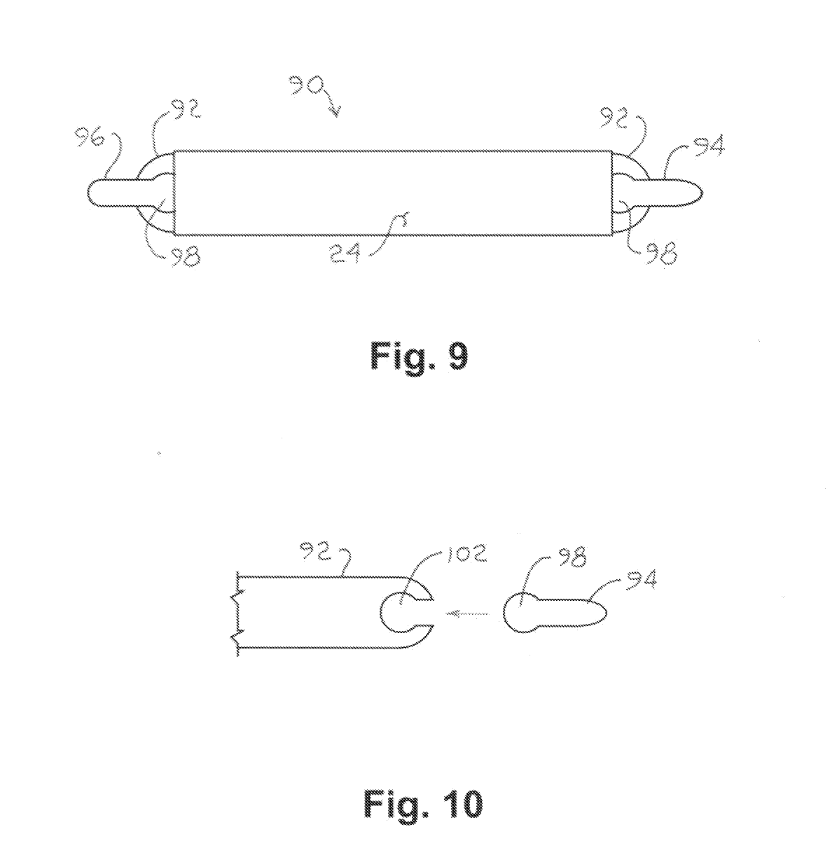

In an exemplary embodiment, a stylus 90 may comprise a core 92 configured for retention of a first nib 94 and an optional second nib 96, as shown in FIG. 9. One or both of the nibs 94, 96 may comprise a tab-like attachment end 98 configured to mate with a respective tab receptacle opening 102 in the core 92, as shown in FIG. 10. During a fabrication procedure, the tab-like attachment ends 98 of the first nib 94 and of the second nib 96 (when used) are inserted into the respective tab receptacles openings 102, and are physically retained thereby. The soft capsule coating 24 may then be formed over the core 92, over some or all of the tab-like attachment end 98 of the first nib 94, and over some or all of the tab-like attachment end 98 of the second nib 96 (when used), to more positively hold the nibs 94, 96 in place, so as to enable fabrication of the stylus 90.

It should be understood that the configuration of the tab-like attachment end 98 is designed to prevent the nibs 94, 96 from falling out of the corresponding tab receptacle 102 during the fabrication procedure, and that the present invention is not limited to the particular shape and size of the tab-like attachment end 98 shown in FIG. 10 but may comprise any shape or size which functions to retain the nibs 94, 96 in the tab receptacles 102.

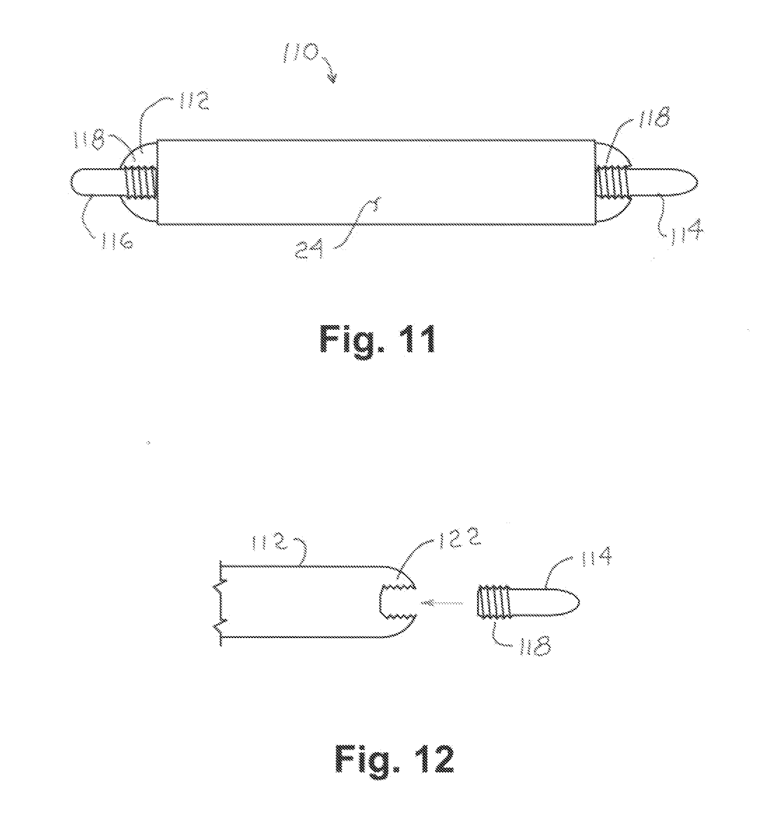

In an exemplary embodiment, a stylus 110 may comprise a core 112 configured to provide attachment means for a first nib 114 and for an optional second nib 116, as shown in FIG. 11. One or both of the nibs 114, 116 may comprise a threaded or ribbed attachment end 118 configured to mate with a respective serrated opening 122 in the core 112, as shown in FIG. 12. The threaded/ribbed geometry of the attachment end 118 may comprise threads, as shown, or may comprise a series of raised features (not shown) about the circumference of the attachment end 118. Accordingly, the first nib 114 may be screwed into the serrated opening 122, if the serrated opening 122 comprises threads, and the nib 114 may be snapped into the serrated opening 122 as known in the relevant art, if the serrated opening 122 comprises raised features.

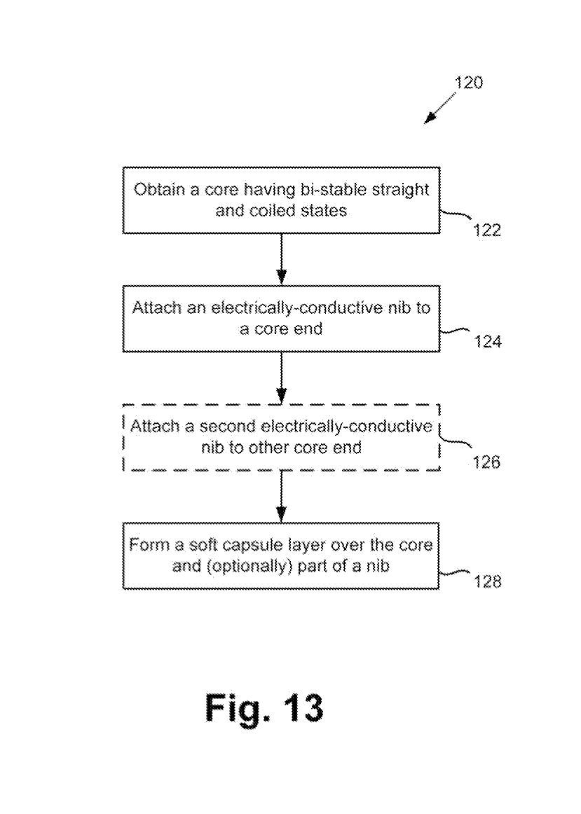

An exemplary embodiment of a method that may be used to fabricate any of the above-described stylus 10, stylus 50, 70, 90, and stylus 110 may follow the fabrication steps shown in a flow diagram 120, in FIG. 13, in which a core is obtained, at step 122, the core having the physical property of being able to remain in either a first bi-stable state having a straightened configuration or second bi-stable state having a coiled configuration. For example, any one of the cores 22, 52, 72, 92, 112 may be so used.

An electrically-conductive nib may be attached to one end of the core, at step 124. In an exemplary embodiment, a second nib may be attached to the other end of the core, at optional step 126. For example, any one or two of the nibs 12, 16, 62, 64, 74, 76, 94, 96, 114, 116 may be so used. A soft capsule layer is then formed overlying and substantially enclosing the core and, optionally, at least part of one of the nibs, at step 128, using a fabrication method as described above, or any fabrication method known in the relevant art that will function to provide a substantially continuous soft capsule layer surrounding and secured to the core.

It is to be understood that the description herein is exemplary of the invention only and is intended to provide an overview for the understanding of the nature and character of the disclosed systems. The accompanying drawings are included to provide a further understanding of various features and embodiments of the apparatuses of the invention which, together with their description serve to explain the principles and operation of the invention.

What is claimed is:

1. A compact conductive stylus comprising:
a core configured to assume and maintain either of two bi-stable states, said core formed from an elongated flexible material;
a first electrically-conductive nib attached to a first end of said core; and
a soft capsule layer substantially enclosing said core.

2. The compact conductive stylus of claim 1 further comprising a second electrically-conductive nib attached to a second end of said core.

3. The compact conductive stylus of claim 1 wherein one of said bi-stable states comprises at least one of a coiled shape for said stylus and a linear shape for said stylus.

4. The compact conductive stylus of claim 1 wherein said core comprises one of a metal and a non-brittle plastic.

5. The compact conductive stylus of claim 1 wherein said core comprises a substantially arcuate cross-sectional shape.

6. The compact conductive stylus of claim 1 wherein said first electrically-conductive nib comprises an electrically-conductive non-metallic material.

7. The compact conductive stylus of claim 1 wherein said first electrically-conductive nib comprises a skirt-like attachment feature for attachment to said core.

8. The compact conductive stylus of claim 1 wherein said first electrically-conductive nib comprises at least one of a tab-like attachment feature, a ribbed end, and a threaded end for attachment to said core.

9. The compact conductive stylus of claim 1 wherein said core comprises a serrated opening for retaining said first electrically-conductive nib.

10. The compact conductive stylus of claim 1 wherein said core comprises a conductive pin for retaining said first electrically-conductive nib.

11. The compact conductive stylus of claim 1 wherein said conductive pin is attached to said core by at least one of a mechanical fastener, a groove, an epoxy, and a solder compound.

12. A compact conductive stylus comprising:
a core configured to assume and maintain either of two bi-stable states, said core having an arcuate cross-sectional shape and formed from an elongated flexible material;
an electrically-conductive nib attached to said core, said electrically- conductive nib formed from a non-metallic material; and
a soft capsule layer enclosing said core.

13. The compact conductive stylus of claim 12 wherein said electrically-conductive nib is attached to said core by at least one of: an open nib cavity, a skirt-like attachment end, a tab-like attachment end, a threaded end, and a ribbed end.

14. The compact conductive stylus of claim 13 wherein said soft capsule layer encloses at least a portion of: said skirt-like attachment end, said tab-like attachment end, said threaded end, or said ribbed attachment end.

15. The compact conductive stylus of claim 12 wherein said soft capsule layer comprises a first capsule layer segment attached to a second capsule layer segment.

16. A method of fabricating a compact conductive stylus, said method comprising the steps of:
obtaining a core configured to selectively assume and maintain either of two bi-stable states;
attaching an electrically-conductive nib to said core; and
enclosing said core in a soft capsule layer substantially overlying said core.

17. The method of claim 16 wherein said core comprises an elongated flexible material having an arcuate cross-sectional shape.

18. The method of claim 16 wherein said electrically-conductive nib comprises non- metallic material.

19. The method of claim 16 wherein said step of enclosing comprises the step of attaching a first capsule layer segment disposed on a first side of said core to a second capsule layer segment disposed on a second side of said core.

20. The method of claim 16 further comprising the step of attaching a second electrically-conductive nib to said core.
